(19) United States
(12) Patent Application Publication
(10) Pub. No.: US 2005/0164082 A1
(43) Pub. Date: Jul. 28, 2005

(54) Nonaqueous electrolyte battery

(76) Inventors: Takashi Kishi, Yokosuka-shi (JP); Hidesato Saruwatari, Kawasaki-shi (JP); Norio Takami, Yokohama-shi (JP); Hiroki Inagaki, Kawasaki-shi (JP); Takashi Kuboki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/042,132

(22) Filed: Jan. 26, 2005

(30) Foreign Application Priority Data
Jan. 27, 2004 (JP) 2004-018624

(51) Int. Cl. H01M 10/36; H01M 10/40; H01M 4/52; H01M 4/50

(52) U.S. Cl. 429/188; 429/199; 429/231.3; 429/224; 429/223

(57) ABSTRACT

A nonaqueous electrolyte battery includes a positive electrode, a negative electrode containing an active material providing a negative electrode working potential which is nobler than a lithium electrode potential, and whose potential difference from the lithium electrode potential is 0.5V or more, and an electrolyte containing molten salt, ester phosphate and metal salt including at least one of alkaline metal salt and alkaline earth metal salt, the electrolyte satisfying the following formula (1):
0.5≦(M₂/M₁)≦1 (1)
where M₁ is a molar number of the metal salt and M₂ is a molar number of the ester phosphate.

### CROSS-REFERENCE TO RELATED APPLICATIONS

This application is based upon and claims the benefit of priority from prior Japanese Patent Application No. 2004-018624, filed Jan. 27, 2004, the entire contents of which are incorporated herein by reference.

### BACKGROUND OF THE INVENTION

1. Field of the Invention

The present invention relates to a secondary battery comprising a nonaqueous electrolyte.

2. Description of the Related Art

Recently, the market of personal digital assistants such as portable telephones and small-sized personal computers is rapidly spreading, and as these appliances are becoming smaller in size and lighter in weight, the power sources for operating them are also demanded to be smaller and lighter. In these portable appliances, lithium ion secondary batteries of high energy density are widely used, and are continuously studied at the present. Along with the recent technical progress, various appliances such as digital audio appliances and POS terminals are much reduced in size. When becoming portable by reduction in size, instead of a conventional alternating-current power source, built-in batteries capable of omitting power cords are demanded, and required applications of secondary batteries are expanding. At the same time, in personal digital assistance such as personal computers, and portable telephone in which secondary batteries have been conventionally used, further enhancement of characteristics is always demanded. In this background, in the secondary batteries, aside from larger capacity, more advanced and versatile characteristics are being demanded. In particular, there is a mounting importance in the aspects of stability in abuse such as overcharging, stability in long-term storage, and maintenance of performances at high temperature. As secondary batteries, hitherto, lead storage battery, nickel-cadmium secondary battery, and nickel-hydrogen secondary battery have been used, but they have problems in the point of small size and light weight. By contrast, the nonaqueous electrolyte secondary battery has a large capacity in spite of small size and light weight, and is therefore widely used in a personal computer, a portable telephone, a digital camera, a video camera, etc.

In this kind of nonaqueous electrolyte secondary battery, lithium-containing cobalt composite oxide or lithium-containing nickel composite oxide is used as a positive electrode active material, a carbon material such as graphite or coke is used as a negative electrode active material, and an organic solvent having dissolved therein a lithium salt such as LiPF₆ or LiBF₄ is used in an electrolyte solution. The positive electrode and negative electrode are formed as sheets. A separator for holding the electrolyte solution is arranged between the positive electrode and negative electrode to isolate the positive and negative electrodes electronically, they are put in cases of individual shapes, and a battery is completed.

Such a nonaqueous electrolyte secondary battery tends to be unstable thermally, at the time of overcharging, due to chemical reaction different from the ordinary charging or discharging. Besides, since the electrolysis solution is mainly composed of a flammable organic solvent, the safety of the battery may be spoiled by combustion of the electrolyte solution.

To solve such problems, it has been studied to change the composition of the electrolyte solution. In the electrolyte solution of organic solvent system, the solvent has been, for example, ethylene carbonate, diethyl carbonate, ethyl methyl carbonate, or gamma-butyrolactone. The flash points of these solvents are sequentially 152° C., 31° C., 24° C., and 98° C., and by using the ethylene carbonate and gamma-butyrolactone of relatively high flash point among them, it has been attempted to enhance the safety of the battery. However, in a passenger car in summer, certain cases exceeding 100° C. have been reported, and such performance was not sufficient.

As another trial, it has been attempted to enhance the safety by using a molten salt which is liquid at ordinary temperature not having flash point as electrolyte. For example, Jpn. Pat. Appln. KOKAI Publication No. 4-349365 discloses a nonaqueous electrolyte secondary battery having a constitution explained below as a secondary battery excellent in safety. This nonaqueous electrolyte secondary battery comprises a positive electrode containing lithium metal oxide, a negative electrode containing a lithium metal, a lithium alloy, or a carbonaceous material intercalating or deintercalating lithium ions, and electrolyte composed of a molten salt formed of lithium salt, aluminum halide and quaternary aluminum halide. Further, Jpn. Pat. Appln. KOKAI Publication No. 11-86905 discloses a nonaqueous electrolyte secondary battery having a constitution explained below as a secondary battery excellent in safety and enhanced in the cycle life and discharge capacity. This nonaqueous electrolyte secondary battery comprises a positive electrode, a negative electrode containing a carbonaceous material intercalating or deintercalating lithium ions, and a molten salt formed of quaternary aluminum ion, lithium ion and anion fluoride of an element selected from boron, phosphorus and sulfur. However, these molten salts are high in viscosity, and low in ion conductivity, and hence extremely low in rate characteristic, and impregnation into the positive and negative electrodes and separator is difficult.

To solve these problems, it has been also attempted to add a nonaqueous solvent hitherto used in diethyl carbonate or ethylene carbonate, to a molten salt. However, if the molten salt is nonflammable, by adding flammable ethylene carbonate, the safety may be sacrificed.

On the other hand, Jpn. Pat. Appln. KOKAI Publication No. 11-329495 discloses a flame retardant nonaqueous electrolyte solution having flame retardant property without sacrificing the battery properties such as charging and discharging efficiency, energy density, output density, and battery life. This flame retardant nonaqueous electrolyte solution comprises an electrolyte (A), a nonaqueous solvent (B), and a quaternary salt (C) of an asymmetrical chemical structure (c) having a conjugate structure and containing nitrogen. The electrolyte (A) includes, among others, lithium tetrafluoroborate, lithium hexafluorophosphate, lithium salt of sulfonyl imide having a specific structural formula, and lithium salt of sulfonyl methide having a specific structural formula. The nonaqueous solvent (B) includes cyclic ester carbonate, chain ester carbonate, ester phosphate, etc. The quaternary salt (C) includes a compound having an imidazolium cation of a specific structural formula.

An embodiment in this Jpn. Pat. Appln. KOKAI Publication No. 11-329495 discloses a lithium secondary battery comprising a nonaqueous electrolyte composed of 19 wt. % of lithium bis(trifluoromethane sulfonyl) imide (TFSILi or LiTFSI), 10 wt. % of trimethyl phosphate (TMP), and 71 wt. % of 1-methyl-3-ethy imidazolium/bis(trifluoromethane sulfonyl) imide salt (MEITFSI or EMI.TFSI), and a negative electrode made of graphite. This publication discloses that this lithium secondary battery shows an excellent charge and discharge characteristic.

### BRIEF SUMMARY OF THE INVENTION

It is hence an object of the invention to realize both excellent rate characteristic and cycle characteristic of a nonaqueous electrolyte battery comprising an electrolyte of high flame retardant property.

According to an aspect of the present invention, there is provided a nonaqueous electrolyte battery comprising:
a positive electrode;
a negative electrode containing an active material providing a negative electrode working potential which is nobler than a lithium electrode potential, and whose potential difference from the lithium electrode potential is 0.5V or more; and
an electrolyte containing molten salt, ester phosphate and metal salt including at least one of alkaline metal salt and alkaline earth metal salt, and the electrolyte satisfying the following formula (1):
   0.5≦(M₂/M₁)≦1 (1)
   where M₁ is a molar number of the metal salt and M₂ is a molar number of the ester phosphate.

### BRIEF DESCRIPTION OF THE SEVERAL VIEWS OF THE DRAWING

FIG. 1 is a sectional view of coin type nonaqueous electrolyte battery that is an embodiment of a nonaqueous electrolyte battery of the present invention;

FIG. 2 is a characteristic diagram showing discharge rate dependency in nonaqueous electrolyte secondary batteries in Examples 1 to 3 and Comparative examples 1 to 9;

FIG. 3 is a characteristic diagram showing cycle characteristics in the nonaqueous electrolyte secondary batteries in Examples 1 to 3 and Comparative examples 1 to 9;

FIG. 4 is a characteristic diagram showing discharge rate dependency in nonaqueous electrolyte secondary batteries in Examples 1, 2 and 5 and Comparative examples 1, 2, 6 and 7;

FIG. 5 is a characteristic diagram showing cycle characteristics in the nonaqueous electrolyte secondary batteries in Examples 1, 2 and 5 and Comparative examples 1, 2, 6 and 7;

FIG. 6 is a characteristic diagram showing discharge rate dependency in nonaqueous electrolyte secondary batteries in Example 4 and Comparative examples 5, 8 and 10;

FIG. 7 is a characteristic diagram showing cycle characteristics in the nonaqueous electrolyte secondary batteries in Example 4 and Comparative examples 2, 5, 8 and 10;

FIG. 8 is a characteristic diagram showing discharge rate dependency in nonaqueous electrolyte secondary batteries in Examples 1, 3 and 4 and Comparative examples 3, 4 and 9; and

FIG. 9 is a characteristic diagram showing cycle characteristics in the nonaqueous electrolyte secondary batteries in Examples 1, 3 and 4 and Comparative examples 3, 4 and 9.

### DETAILED DESCRIPTION OF THE INVENTION

A nonaqueous electrolyte secondary battery according to the present invention comprises an electrolyte containing molten salt, ester phosphate and metal salt including at least of alkaline metal salt and alkaline earth metal salt. Therefore, it is possible to increase nonflammability and flame retardance of the electrolyte, so that the thermal stability of the battery can be enhanced dramatically. Further, the ester phosphate can lower the viscosity of electrolyte without sacrificing the flame retardance of the electrolyte, and the impregnation performance of electrolyte can be enhanced by the surface activity effect. As a result, a nonaqueous electrolyte battery excellent in rate characteristic and capacity characteristic and high in safety can be realized. This secondary battery can also improve the charge and discharge cycle characteristic.

A nonaqueous electrolyte secondary battery comprises a positive electrode, a negative electrode, and an electrolyte containing molten salt, ester phosphate and metal salt including at least of alkaline metal salt and alkaline earth metal salt.

A positive electrode, a negative electrode, and an electrolyte will be described below.

1) Positive Electrode

A positive electrode contains a positive electrode active material, and can also contain an electron conductive substance such as carbon, or a binder for forming into sheet or pellet shape. And the positive electrode can contain a base material such as an electron conductive metal. The base material can be used as a current collector. The positive electrode active material can be used in contact with the current collector.

Examples of the positive electrode active material include a material capable of intercalating and deintercalating alkaline metal ions of lithium, sodium, etc., or alkaline earth metal ions of calcium, etc. In order to obtain a large battery capacity, it is preferred to use a metal oxide that is capable of intercalating and deintercalating lithium ions and is small in weight per electric charge, and various oxides may be used, for example, lithium-containing cobalt composite oxide, lithium-containing nickel cobalt composite oxide, lithium-containing nickel composite oxide, lithium manganese composite oxide and lithium-containing vanadium oxide. And chalcogen compounds may be used, for example, titanium disulfide and molybdenum disulfide. Above all, it is preferred to use a lithium composite oxide containing at least one metal element selected from the group consisting of cobalt, manganese, and nickel, and in particular it is preferred to use lithium-containing cobalt composite oxide, lithium-containing nickel cobalt composite oxide, and manganese composite oxide containing lithium, having charge and discharge potential of 3.8V or more over the lithium electrode potential, because a high battery capacity can be realized. It is also preferred to use a positive electrode active material expressed as LiCoₓNi_{y}Mn_{z}O₂ (x+y+z=1, 0<x≦0.5, 0≦y<1, 0≦z<1) because the decomposition reaction of the molten salt can be suppressed on the positive electrode surface at room temperature or higher.

As the binder, it is preferred to use polytetrafluoroethylene (PTFE), polyvinylidene fluoride (PVdF), ethylene-propylene-diene copolymer, or styrene-butadiene rubber.

The current collector may be composed of metal foil, thin plate, mesh, wire mesh or the like of aluminum, stainless steel, titanium or the like.

The positive electrode active material and conductive material are formed into pellets or sheet by kneading or rolling by adding the binder. Or they may be dissolved in solvent such as toluene, N-methyl pyrrolidone (NMP), or the like, and suspended to form slurry, which may be applied to the current collector, and dried into a sheet.

2) Negative Electrode

The negative electrode contains a negative electrode active material, and is formed into pellets, thin plate, or sheet, by using a conductive agent or binder.

The negative electrode active material is, similar to the positive electrode, capable of intercalating and deintercalating alkaline metal ions of lithium, sodium, etc., or alkaline earth metal ions of calcium, etc. And the negative electrode active material is capable of intercalating and deintercalating metal ions of the same type as in the positive electrode at a potential much baser than the positive electrode. A material intercalating and deintercalating lithium ions is desired because a large battery capacity can be obtained. Such characteristics are realized by, for example, the lithium metals, carbonaceous materials, lithium titanate, iron sulfide, cobalt oxide, lithium-aluminum alloy, and tin oxide. The examples of the carbonaceous materials include artificial graphite, natural graphite, hardly graphitizing carbon material, and carbon material prepared by heat treating graphitizing material at low temperature. As the active material, preferably, the negative electrode working potential should be nobler by 0.5V or more than the lithium electrode potential. By selecting such an active material, it is possible to suppress deterioration by side reaction on the negative electrode active material surface of molten salt and ester phosphate, so that the cycle characteristic and storage characteristic of the secondary battery can be enhanced. From this point of view, lithium titanate and iron sulfide are preferable as the negative electrode active material. Two or more types of negative electrode active material may be mixed and used. The negative electrode active material may be formed in various shapes, including scales, fibers, and spheres.

Examples of lithium titanate include Li₄₊ₓTi₅O₁₂ (−1≦x≦3), and Li₂Ti₃O₇.

As mentioned above, in order to suppress the decomposition reaction of ester phosphate, the negative electrode working potential should be preferred to be 0.5V or more than the lithium electrode potential. By controlling this potential difference to 0.5V or more and 3V or less, decomposition reaction of ester phosphate can be suppressed, and a higher battery voltage can be obtained at the same time. A more preferred range is 0.5V or more and 2V or less.

The active material providing a negative electrode working potential of a potential difference from the lithium electrode of less than 0.5V is, for example, a graphitized material. A graphitized material produces intercalating and deintercalating reaction of lithium at around 0V on the basis of the lithium electrode potential, and therefore, parallel to the charge and discharge reaction, that is, lithium intercalating and deintercalating reaction, decomposition reaction of ester phosphate is progressed. As a result, as shown in the examples below, the rate characteristic and charge and discharge cycle life are worsened.

As the conductive material, an electron conductive substance may be used such as carbon and metal. It may be preferably used in powder or fibrous powder form.

The binder is any one of polytetrafluoroethylene (PTFE), polyvinylidene fluoride (PVdF), styrene-butadiene rubber, carboxymethyl cellulose (CMC), etc. The current collector can be any one of metal foil, thin plate, mesh, wire mesh or the like of copper, stainless steel, nickel or the like.

The negative electrode active material and conductive material are formed in pellets or sheets by kneading and rolling by adding the binder. Alternatively, they may be dissolved in a solvent such as water, N-methylpyrrolidone (NMP), or the like, and suspended to form slurry, which may be applied to the current collector, and dried into a sheet.

3) Electrolyte

The electrolyte contains molten salt, ester phosphate and metal salt including at least of one of alkaline metal salt and alkaline earth metal salt.

The molten salt is preferred to be in a molten state around room temperature in order to operate the battery at ordinary temperature. A cation forming the molten salt is not particularly specified, but preferred examples thereof include aromatic quaternary ammonium ion and aliphatic quaternary ammonium ion. The cation in the molten salt may be composed of one or two or more types.

The aromatic quaternary ammonium ion includes, for example, 1-ethyl-3-methyl imidazolium, 1-methyl-3-propyl imidazolium, 1-methyl-3-isopropyl imidazolium, 1-butyl-3-methyl imidazolium, 1-ethyl-2,3-dimethyl imidazolium, 1-ethyl-3,4-dimethyl imidazolium, N-propyl pyridinium, N-butyl pyridinium, N-tert-butyl pyridinium, and N-tert-pentyl pyridinium.

The aliphatic quaternary ammonium ion includes, for example, N-butyl-N,N,N-trimethyl ammonium, N-ethyl-N,N-dimethyl-N-propyl ammonium, N-butyl-N-ethyl-N,N-dimethyl ammonium, N-butyl-N,N-dimethyl-N-propyl ammonium, N-methyl-N-propyl pyrrolidinium ion, N-butyl-N-methyl pyrrolidinium ion, N-methyl-N-pentyl pyrrolidinium, N-propoxy ethyl-N-methyl pyrrolidinium, N-methyl-N-propyl piperidinium, N-methyl-N-isopropyl piperidinium, N-butyl-N-methyl piperidinium, N-isobutyl-N-methyl piperidinium, N-sec-butyl-N-methyl piperidinium, N-methoxy ethyl-N-methyl piperidinium, and N-ethoxy ethyl-N-methyl piperidinium.

Among these examples of the aliphatic quaternary ammonium ion, nitrogen-containing five-ring pyrrolidinium ion and nitrogen-containing six-ring piperidinium ion are preferred because the resistance to reduction is high and side reactions are suppressed, so that the storage stability and cycle performance are enhanced.

Among these examples of the aromatic quaternary ammonium ion, the cation having an imidazolium structure is preferred because the molten salt of low viscosity is obtained and a high battery rate characteristic is obtained when used as electrolyte. Further, as the negative electrode active material, when an active material of which working potential is nobler at least 0.5V than the lithium electrode potential is used, the side reaction on the negative electrode is suppressed even in the molten salt containing the cation having the imidazolium structure, and a nonaqueous electrolyte secondary battery excellent in storage stability and cycle characteristic can be obtained.

The anion for forming the molten salt is not particularly specified, but one or more types may be selected from tetrafluoroborate anion (BF₄⁻), hexafluorophosphate anion (PF₆⁻), hexafluoromethane sulfonate anion, bis(trifluoromethane sulfonyl) amide anion (TFSI), and dicyanamide anion (DCA).

The alkaline metal salt includes lithium salt and sodium salt, and the alkaline earth metal salt includes calcium salt. In particular, lithium salt is preferred because a large battery capacity can be obtained. As the lithium salt, one or more types may be selected from lithium tetrafluoroborate (LiBF₄), lithium hexafluorophosphate (LiPF₆), lithium hexafluoromethane sulfonate, lithium bis(trifluoromethane sulfonyl) amide (LiTFSI), lithium bis(pentafluoroethane sulfonyl) amide (LiBETI), and lithium dicyanamide (LiDCA).

The metal salt concentration including at least one of alkaline metal salt and alkaline earth metal salt is preferred to be 0.1 to 2.5 mol/L. If the metal salt concentration is less than 0.1 mol/L, sufficient ion conductivity is not obtained, so that the discharge capacity may be lowered. If the metal salt concentration exceeds 2.5 mol/L, the viscosity of the molten salt is extremely elevated. Therefore, the impregnation property into the positive and negative electrodes is lowered, which may lead to reduction of discharge capacity. In order to avoid salt deposition and obtain a sufficient ion conductivity even at 0° C. or less, a more preferred range is 0.5 to 1.8 mol/L.

The ester phosphate is not particularly specified, and trimethyl phosphate, triethyl phosphate, tributyl phosphate, triphenyl phosphate and the like may be used. One or two or more types of ester phosphate may be used. In particular, one of low molecular weight is preferred because the viscosity is low and the flame retardant effect is high, and trimethyl phosphate is most preferred because the molecular weight is the lowest and the flame retardant effect is high.

As a result of further promotion of researches by the present inventors, it has been found that both rate characteristic and cycle characteristic at room temperature and high temperature can be satisfied by defining the molar ration (M₂/M₁) to 0.5 or more and 1 or less, that is, M₁:M₂ at 1:0.5 to 1:1, and by using the negative electrode having the active material providing a negative electrode working potential at a nobler potential than the lithium electrode potential, with the potential difference from the lithium electrode potential of 0.5V or more. This is because by using the negative electrode at the specified molar ratio (M₂/M₁) range, increase of internal resistance and drop of capacity due to decomposition of ester phosphate on the negative electrode can be suppressed for a long period and for a long cycle. Although the specific reason is not clear, when the molar ratio (M₂/M₁) exceeds 1, that is, the molar number of the ester phosphate is greater than the molar number of the metal salt, ester phosphate which is more likely to react is produced in the nonaqueous electrolyte, and it is estimated that decomposition of ester phosphate may be promoted. A more preferred molar ratio (M₂/M₁) is 0.8 or more and 1 or less. In such a composition, the viscosity drop and reactivity suppression are balanced, and high battery rate characteristic and long-term stability are both satisfied. Incidentally, the M₁ is a molar number of the metal salt and the M₂ is a molar number of the ester phosphate.

In the secondary battery comprising the negative electrode having the active material providing such a negative electrode working potential, and the nonaqueous electrolyte of which molar ratio (M₂/M₁) is 0.5 or more and 1 or less, it is preferred to use a molten salt containing a cation component having an imidazolium structure. As a result, a nonaqueous electrolyte having both high ion conductivity and excellent electrochemical stability is obtained.

Further, in the secondary battery comprising the negative electrode having the active material providing such a negative electrode working potential, and the nonaqueous electrolyte of which molar ratio (M₂/M₁) is 0.5 or more and 1 or less, it is preferred to use a molten salt presenting tetrafluoroborate ions. As a result, ion conductivity of the nonaqueous electrolyte is enhanced.

The electrolyte is preferred to contain no organic solvent other than ester phosphate in order to obtain a higher flame retardant effect. However, in consideration of side reaction suppressing effect in the battery and enhancement of affinity for the separator and others, another organic solvent may be also contained. However, to assure the flame retardant effect, the content should be preferably 10 wt. % or less. To avoid possibility of combustion in case of leak of the electrolyte from the battery, the content of another organic solvent should be as small as possible, and more specifically the content of another organic solvent should be limited to such an extent that the flash point of the electrolyte after mixing another organic solvent may not be lowered by more than 10° C. from the flash point before mixing. If another organic solvent is added for side reaction suppression such as suppression of chemical reaction in the battery, it is preferred that more than half of the content may be consumed after composing the battery or after finishing the initial charge and discharge. Therefore, the content should be preferably 3 wt. % or less.

Carbon dioxide may be contained in the electrolyte. Since carbon dioxide is noncombustible gas, side reaction on the negative electrode surface is suppressed without sacrificing the flame retardant property, so that suppressing effect of internal impedance and enhancing effect of cycle characteristic are obtained.

The nonaqueous electrolyte battery of the invention may be manufactured in various forms including cylinder, prism, flat plate, and coin. An embodiment of a coin type nonaqueous electrolyte battery is shown in FIG. 1.

A metal positive electrode case 1 serving also as a positive electrode terminal accommodates a positive electrode 2 in pellets. A separator 3 is laminated on the positive electrode 2. A negative electrode 4 in pellets is laminated on the separator 3. A nonaqueous electrolyte is impregnated in the positive electrode 2, separator 3, and negative electrode 4. A metal negative electrode case 5 serving also as a negative electrode terminal is crimped and fixed to the positive electrode case 1 with its inside contacting with the negative electrode 4 by way of an insulating gasket 6.

The separator 3 is formed from, for example, a synthetic resin nonwoven fabric, a polyethylene porous film, a polypropylene porous film, a cellulose porous sheet, etc.

The positive electrode case 1 and negative electrode case 5 are made of, for example, stainless steel, iron or the like.

The insulating gasket 6 is formed of, for example, polypropylene, polyethylene, vinyl chloride, polycarbonate, polytetrafluoroethylene, etc.

FIG. 1 shows the coin type case, but other cases may be similarly used, such as a cylindrical or prismatic case, a laminate film bag, and others.

Examples of the invention are described below by referring to the accompanying drawings and tables. In the following examples, the battery structure as shown in FIG. 1 is employed.

### EXAMPLE 1

A composition of 90 wt. % of lithium cobalt oxide (LiCoO₂) powder, 2 wt. % of acetylene black, 3 wt. % of graphite, and 5 wt. % of polyvinylidene fluoride as binder was dispersed in a solvent of N-methyl pyrrolidone to form a slurry, which was applied on an aluminum foil of 20 μm in thickness, and dried and pressed. The obtained positive electrode sheet was cut in a circular form of 15 mm in diameter, and a positive electrode was manufactured. The positive electrode weight was 17.8 mg. The charge and discharge potential of the obtained positive electrode was about 4.0 to 4.3V to the lithium electrode potential.

A composition of 90 wt. % of Li_{4/3}Ti_{5/3}O₄ powder as the negative electrode active material, 5 wt. % of artificial graphite as the conductive material, and 5 wt. % of polyvinylidene fluoride (PVdF) was added in a solution of N-methylpyrrolidone (NMP) and mixed, and the obtained slurry was applied on an aluminum foil of 20 μm in thickness, and dried and pressed. The obtained negative electrode sheet was cut in a circular form of 16 mm in diameter, and a negative electrode was manufactured. The negative electrode weight was 15.5 mg. The working potential of the obtained negative electrode was about 1.4 to 1.6V nobler than the lithium electrode potential.

The separator was formed of polypropylene nonwoven fabric.

In 1-ethyl-3-methyl imidazolium tetrafluoroborate (EMI.BF₄), 0.5 mol/L of lithium tetrafluoroborate (LiBF₄) was dissolved to prepare an electrolyte, and trimethyl phosphate (TMP) was added to a molar ratio (M₂/M₁) of 1.0, and a nonaqueous electrolyte was obtained. Herein, M₁ is the molar number of LiBF₄, and M₂ is the molar number of TMP.

The positive electrode was put into the coin type positive electrode case, the negative electrode was arranged on the positive electrode by way of the separator. And the nonaqueous electrolyte was poured into the positive electrode, negative electrode and separator in vacuum. By crimping and fixing the coin type negative electrode case by way of insulating gasket, a coin type nonaqueous electrolyte secondary battery was manufactured. As calculated from the active material amount contained in the electrode, the theoretical capacity was 1.25 mAh.

### EXAMPLES 2 AND 3 AND COMPARATIVE EXAMPLES 6 TO 9

Coin type nonaqueous electrolyte secondary batteries were manufactured in the same manner as in Example 1, except that types of molten salt, lithium salt and ester phosphate, and the molar ratio (M₂/M₁) were changed as shown in Table 1.

In Table 1, EMI.TFSI is 1-ethyl-3-methyl imidazolium bis(trifluoromethane sulfonyl) amide, 14P5.TFSI is N-butyl-N-methyl pyrrolidinium bis(trifluoromethane sulfonyl) amide, 13P6.TFSI is N-methyl-N-propyl piperidinium bis(trifluoromethane sulfonyl) amide, LiTFSI is lithium bis(trifluoromethane sulfonyl) amide, and TEP is triethyl phosphate.

### COMPARATIVE EXAMPLE 1

A nonaqueous electrolyte secondary battery was manufactured in the same manner as in Example 1, except that the nonaqueous electrolyte was prepared by dissolving 0.5 mol/L of lithium tetrafluoroborate (LiBF₄) in 1-ethyl-3-methyl imidazolium tetrafluoroborate (EMI.BF₄).

### COMPARATIVE EXAMPLE 2

A nonaqueous electrolyte secondary battery was manufactured in the same manner as in Example 1, except that the nonaqueous electrolyte was prepared by adding 5 wt. % of nonafluoromethoxy butylene to the electrolyte obtained by dissolving 0.5 mol/L of lithium tetrafluoroborate (LiBF₄) in 1-ethyl-3-methyl imidazolium tetrafluoroborate (EMI.BF₄).

### COMPARATIVE EXAMPLE 3

A nonaqueous electrolyte secondary battery was manufactured in the same manner as in Example 1, except that the nonaqueous electrolyte was prepared by dissolving 0.5 mol/L of lithium bis(trifluoromethane sulfonyl) amide (LiTFSI) in N-butyl-N-methyl pyrrolidinium bis(trifluoromethane sulfonyl) amide (14P5.TFSI).

### COMPARATIVE EXAMPLE 4

A nonaqueous electrolyte secondary battery was manufactured in the same manner as in Example 1, except that the nonaqueous electrolyte was prepared by adding 5 wt. % of nonafluoromethoxy butylene to the electrolyte obtained by dissolving 0.5 mol/L of lithium bis(trifluoromethane sulfonyl) amide (LiTFSI) in N-methyl-N-propyl piperidinium bis(trifluoromethane sulfonyl) amide (13P6.TFSI).

### COMPARATIVE EXAMPLE 5

A nonaqueous electrolyte secondary battery was manufactured in the same manner as in Example 1, except that the nonaqueous electrolyte was prepared by dissolving 0.5 mol/L of lithium bis(trifluoromethane sulfonyl) amide (LiTFSI) in 1-ethyl-3-methyl imidazolium bis(trifluoromethane sulfonyl) amide (EMI.TFSI).

TABLE 1

| | Molten | Lithium | Organic solvent | Molar ratio |
|---|---|---|---|---|
| | salt | salt (M₁) | (M₂) | (M₂/M₁) |
| Example 1 | EMI · BF₄ | LiBF₄ | TMP | 1.0 |
| Comparative Example 6 | EMI · BF₄ | LiBF₄ | TMP | 0.2 |
| Comparative Example 7 | EMI · BF₄ | LiBF₄ | TMP | 2.0 |
| Example 2 | EMI · BF₄ | LiBF₄ | TEP | 0.75 |
| Comparative Example 8 | EMI · TFSI | LiTFSI | TMP | 1.2 |
| Comparative Example 9 | 14P5 · TFSI | LiTFSI | TMP | 1.1 |
| Example 3 | 13P6 · TFSI | LiTFSI | TMP | 1.0 |
| Example 4 | EMI · TFSI | LiTFSI | TMP | 0.8 |
| Example 5 | EMI · BF₄ | LiBF₄ | TMP | 0.5 |
| Comparative Example 1 | EMI · BF₄ | LiBF₄ | None | — |
| Comparative Example 2 | EMI · BF₄ | LiBF₄ | Nonafluoromethoxy | — |
| | | | butylene | |
| Comparative Example 3 | 14P5 · TFSI | LiTFSI | None | — |
| Comparative Example 4 | 13P6 · TFSI | LiTFSI | Nonafluoromethoxy | — |
| | | | butylene | |
| Comparative Example 5 | EMI · TFSI | LiTFSI | None | — |

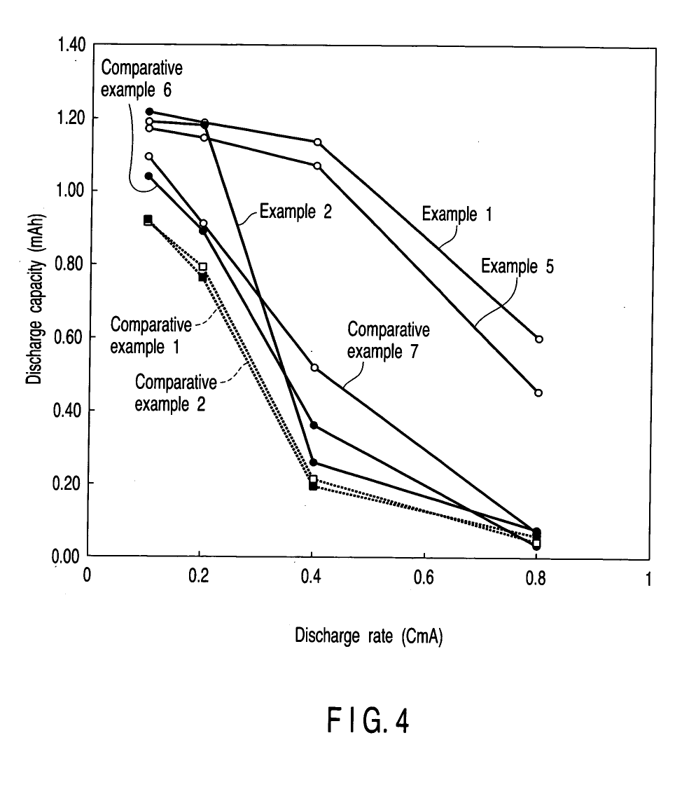

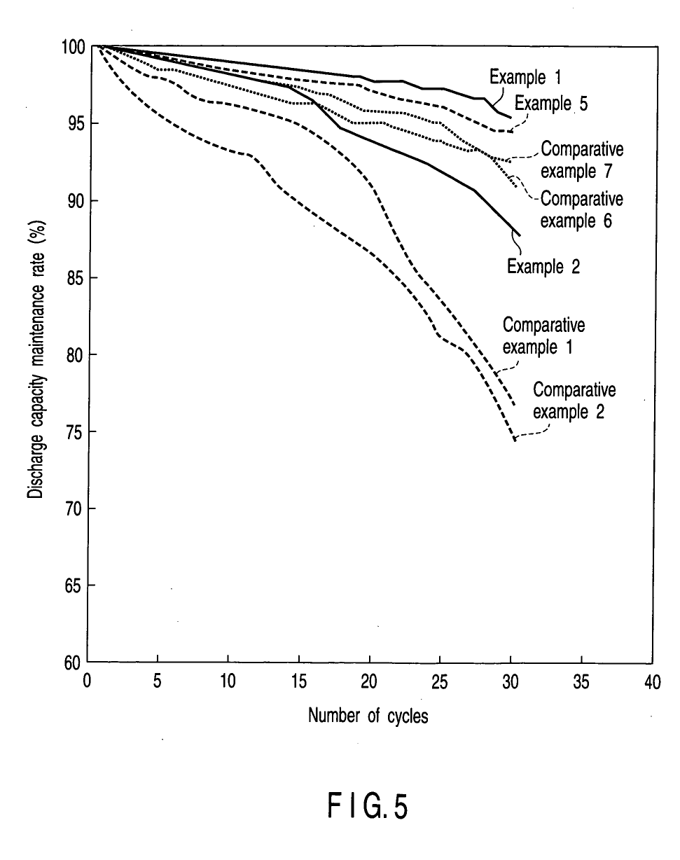

TABLE 2
(corresponding to FIGS. 4 and 5)

| | | | | | 20th cycle |
|---|---|---|---|---|---|
| | Molten | Lithium | Organic solvent | Molar ratio | capacity at 60° C. |
| | salt | salt (M₁) | (M₂) | (M₂/M₁) | (mAh) |
| Example 1 | EMI·BF₄ | LiBF₄ | TMP | 1.0 | 68.4 |
| Example 2 | EMI.BF₄ | LiBF₄ | TEP | 0.75 | 65.5 |
| Example 5 | EMI.BF₄ | LiBF₄ | TMP | 0.5 | 56.2 |
| Comparative | EMI.BF₄ | LiBF₄ | None | — | 41.2 |
| Example 1 | | | | | |
| Comparative | EMI.BF₄ | LiBF₄ | Nonafluoromethoxy | — | 40.9 |
| Example 2 | | | butylene | | |
| Comparative | EMI.BF₄ | LiBF₄ | TMP | 0.2 | 45.2 |
| Example 6 | | | | | |
| Comparative | EMI.BF₄ | LiBF₄ | TMP | 2.0 | 48.7 |
| Example 7 | | | | | |

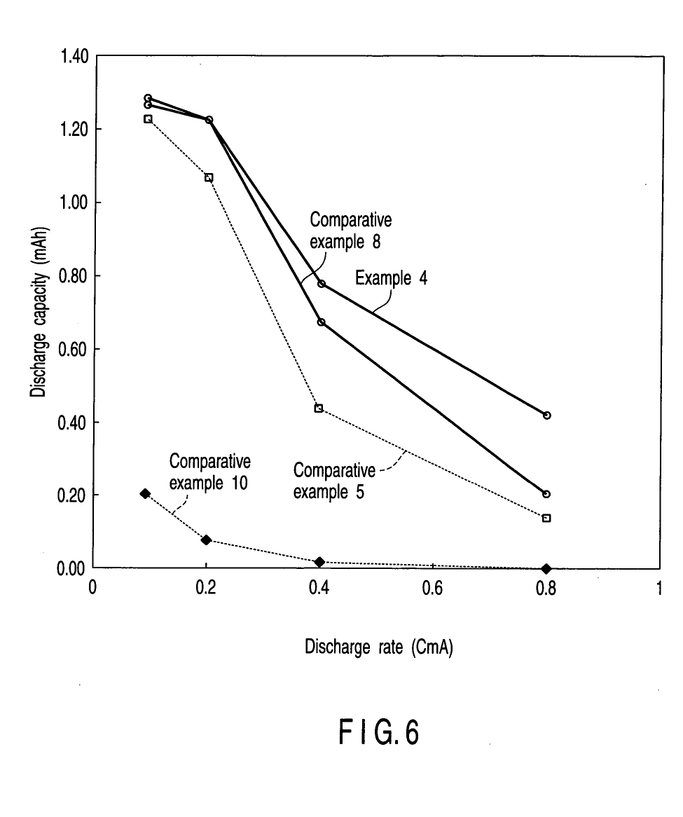

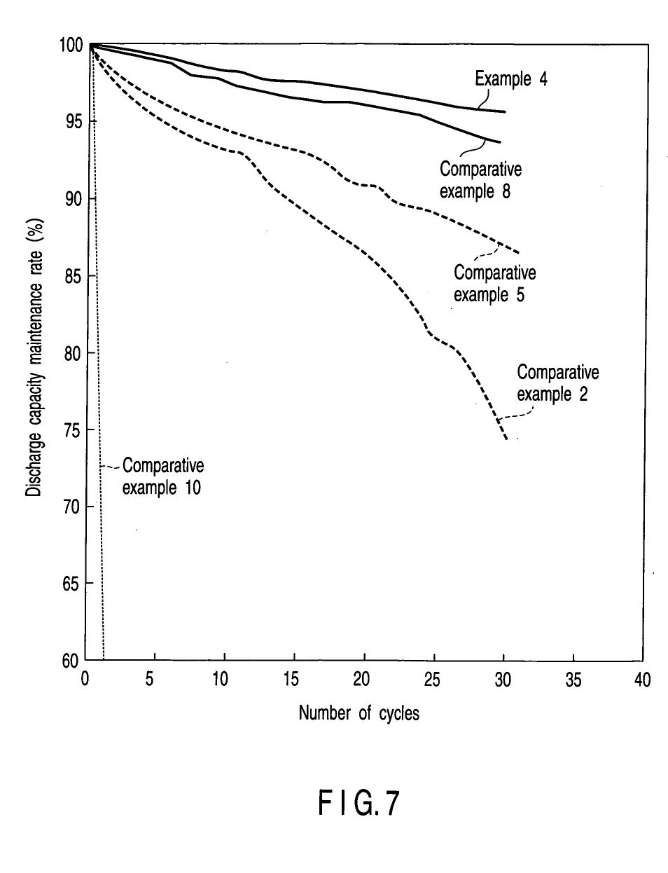

TABLE 3
(corresponding to FIGS. 6 and 7)

| | | | | | 20th cycle |
|---|---|---|---|---|---|
| | Molten | Lithium | Organic solvent | Molar ratio | capacity at |
| | salt | salt (M₁) | (M₂) | (M₂/M₁) | 60° C. (mAh) |
| Example 4 | EMI.TFSI | LiTFSI | TMP | 0.8 | 45.3 |
| Comparative | EMI.BF₄ | LiBF₄ | Nonafluoromethoxy | — | 40.9 |
| Example 2 | | | butylene | | |
| Comparative | EMI.TFSI | LiTFSI | None | — | 27.4 |
| Example 5 | | | | | |
| Comparative | EMI.TFSI | LiTFSI | TMP | 1.2 | 35.2 |
| Example 8 | | | | | |
| Comparative | EMI.TFSI | LiTFSI | TMP | 1.1 | 0.0 |
| Example 10 | | | | | |

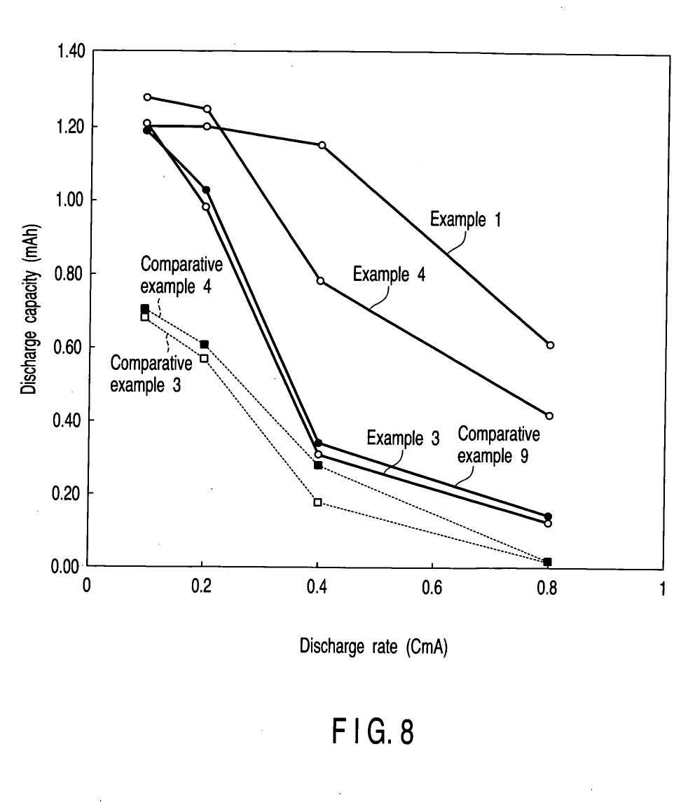

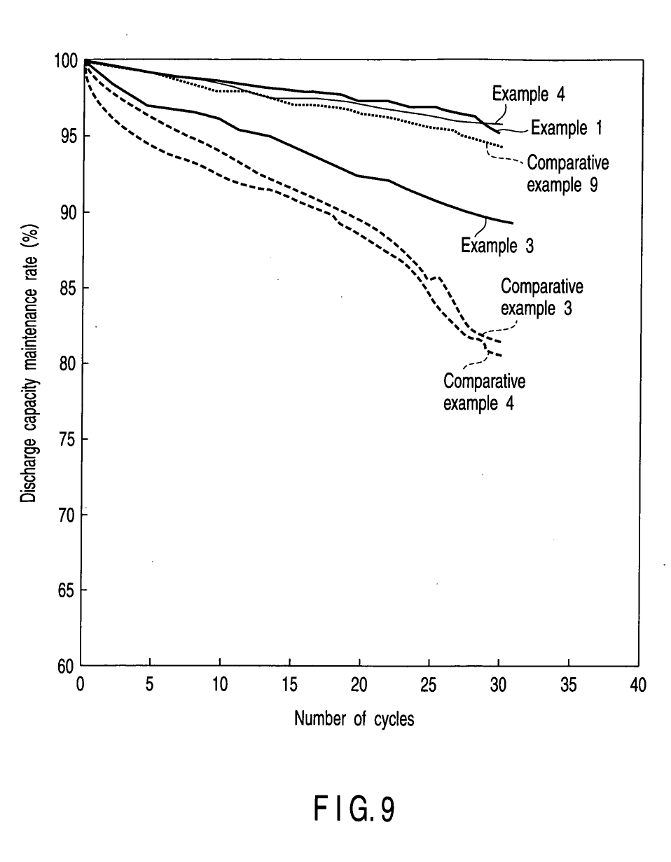

TABLE 4
(corresponding to FIGS. 8 and 9)

| | | | | | 20th cycle |
|---|---|---|---|---|---|
| | Molten | Lithium | Organic solvent | Molar ratio | capacity at 60° C. |
| | salt | salt (M₁) | (M₂) | (M₂/M₁) | (mAh) |
| Example 1 | EMI.BF₄ | LiBF₄ | TMP | 1.0 | 68.4 |
| Example 3 | 13P6.TFSI | LiTFSI | TMP | 1.0 | 52.3 |
| Example 4 | EMI.TFSI | LiTFSI | TMP | 0.8 | 45.3 |
| Comparative | 14P5.TFSI | LiTFSI | None | — | 19.4 |
| Example 3 | | | | | |
| Comparative | 13P6.TFSI | LiTFSI | Nonafluoromethoxy | — | 29.2 |
| Example 4 | | | butylene | | |
| Comparative | 14P5.TFSI | LiTFSI | TMP | 1.1 | 21.3 |
| Example 9 | | | | | |

Evaluation of Rate Characteristic

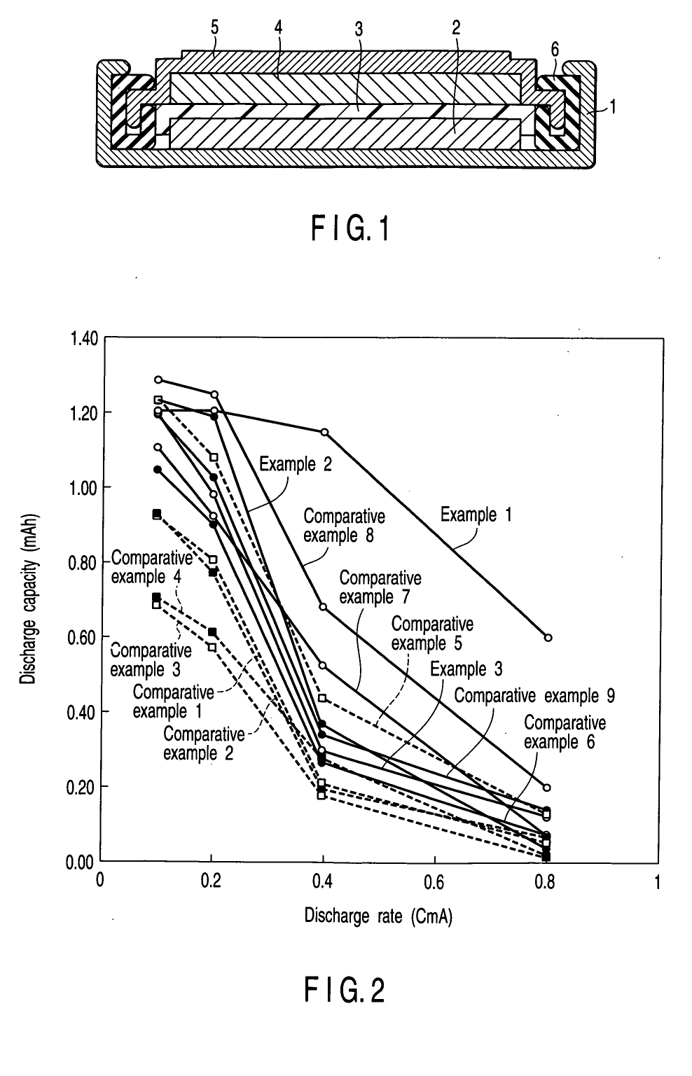

The obtained nonaqueous electrolyte secondary batteries in Examples 1 to 3, Comparative examples 1 to 9 were charged at constant current of 0.2 CmA up to 2.8V, and further charged at constant voltage of 2.8V for a total duration of 10 hours. The batteries were later discharged at constant current of 0.1 CmA. The batteries were charged again in the same condition, and discharged at constant current of 0.2 CmA. Further, after charging in the same condition, the batteries were discharged at constant current of 0.4 CmA and 0.8 CmA. By this evaluation, the discharge capacity was obtained, and the results are shown in FIG. 2.

Evaluation of Cycle Characteristic

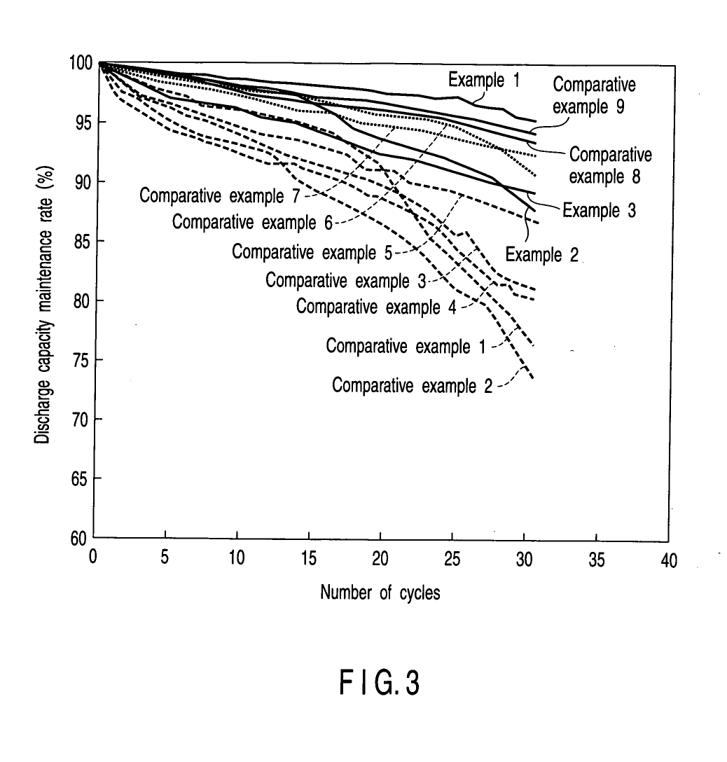

After the above evaluation of the batteries in Examples 1 to 3 and Comparative examples 1 to 9, the cycle was evaluated. Similarly, the batteries were charged at constant current of 0.2 CmA up to 2.8V, and further charged at constant voltage of 2.8V for a total duration of 10 hours. The batteries were later discharged at constant current of 0.2 CmA until 1.5V. The circuit opening time between charge and discharge was 30 minutes. Transition of discharge capacity obtained by the cycle evaluation is shown in FIG. 3. FIG. 3 shows the maintenance rate on the basis of 100% as the discharge capacity of each battery upon start of cycle evaluation.

### EXAMPLE 4

A nonaqueous electrolyte secondary battery was manufactured in the same manner as in Example 1, except that the molar ratio (M₂/M₁) of the molar number M₁ of LiBF₄ and molar number M₂ of TMP was 0.8.

### EXAMPLE 5

A nonaqueous electrolyte secondary battery was manufactured in the same manner as in Example 1, except that the molar ratio (M₂/M₁) of the molar number M₁ of LiBF₄ and molar number M₂ of TMP was 0.5.

### COMPARATIVE EXAMPLE 10

A composition of 87 wt. % of graphite powder, 10 wt. % of artificial graphite of average particle size of 5 μm, 1 wt. % of carboxymethyl cellulose, and 2 wt. % of styrene butadiene rubber were dispersed in water and a slurry was formed. The obtained slurry was applied on a copper foil, and dried, and a negative electrode sheet was prepared.

The obtained negative electrode sheet was cut out in a circular form of 16 mm in diameter, and a negative electrode was obtained. The negative electrode weight was 26.3 mg. The working potential of the negative electrode was 0 to 0.2V to the lithium electrode potential (0 to 0.2V vs. Li/Li⁺).

A nonaqueous electrolyte was prepared by adding trimethyl phosphate (TMP) to a molar ratio (M₂/M₁) of 1.1 after dissolving 1.2 mol/L of lithium bis(trifluoromethane sulfonyl) amide (LiTFSI) in 1-ethyl-3-methyl imidazolium bis(trifluoromethane sulfonyl) amide (EMI.TFSI). A nonaqueous electrolyte secondary battery was manufactured in the same manner as in Example 1, except that the nonaqueous electrolyte and negative electrode were manufactured as described above.

In the obtained secondary batteries in Examples 4 and 5 and Comparative example 10, the rate characteristic and cycle characteristic were evaluated same as described above.

Further, the secondary batteries in Examples 4 and 5 and Comparative example 10, and the secondary batteries in Examples 1 to 3 and Comparative examples 1 to 9 were evaluated by high temperature cycle characteristic test in the following conditions. First, in a thermostatic oven at 60° C., the batteries were charged at constant current of 0.2 CmA up to 2.8V, and further charged at constant voltage of 2.8V for a total duration of 10 hours. The batteries were later discharged at constant current of 0.2 CmA. After repeating 20 cycles of charge and discharge, and the discharge capacity at the 20th cycle is shown in Tables 2 to 4.

In order to minimize effects by difference in type of molten salt, the secondary batteries were classified in three groups, that is, a first group using EMI.BF₄ as molten salt, a second group using mainly EMI.TFSI, and third group using mainly others as molten salt. In the first group consisting of secondary batteries in Examples 1, 2 and 5 and Comparative examples 1, 2, 6 and 7, the rate characteristic is shown in FIG. 4, the cycle characteristic in FIG. 5, and the high temperature cycle characteristic in Table 2. In the second group consisting of secondary batteries in Example 4 and Comparative examples 2, 5, 8 and 10, the rate characteristic is shown in FIG. 6, the cycle characteristic in FIG. 7, and the high temperature cycle characteristic in Table 3. In the third group consisting of secondary batteries in Examples 1, 3 and 4 and Comparative example 3, 4, and 9, the rate characteristic is shown in FIG. 8, the cycle characteristic in FIG. 9, and the high temperature cycle characteristic in Table 4.

The first group is explained. In FIG. 4, the secondary batteries in Examples 1, 2 and 5 and Comparative examples 6 and 7 using ester phosphate produced larger discharge capacity than the secondary battery of Comparative example 1 not containing ester phosphate, at any discharge rate of 0.1C, 0.2C, 0.4C, and 0.8C, and are superior in rate characteristic. A higher capacity is also obtained as compared with the secondary battery in Comparative example 2 containing nonflammable nonafluorometehoxy butylene which is a kind of substitute solvent for chlorofluorocarbon.

Comparing Examples 1 and 5 and Comparative examples 6 and 7 using TMP as organic solvent, in the secondary battery of Example 1 having molar ratio (M₂/M₁) of 0.8 to 1, decline of discharge capacity in the process of elevation of discharge rate from 0.1C to 0.2C, 0.4C, and 0.8C was smaller than in Example 5 with molar ratio (M₂/M₁) of 0.5, Comparative example 6 with molar ratio (M₂/M₁) of less than 0.5, and Comparative example 7 with molar ratio (M₂/M₁) of more than 1, and it is understood that a particularly excellent rate characteristic is obtained. In the secondary battery in Example 2 using TEP higher in molecular weight than TMP and hence more likely to evaporate as the organic solvent, as compared with the secondary batteries in Comparative examples 6 and 7, a notable increase in discharge capacity was recognized at 0.1C and 0.2C.

In FIG. 5, the secondary batteries in Examples 1, 2 and 5 and Comparative examples 6 and 7 using ester phosphate were higher in discharge capacity maintenance rate after 30 cycles, as compared with the secondary batteries in Comparative examples 1 and 2. Comparing Examples 1 and 5 and Comparative examples 6 and 7 using TMP as organic solvent, in the secondary battery of Example 1 having molar ratio (M₂/M₁) of 0.8 to 1, the discharge capacity maintenance rate after 30 cycles was about 95.4%, being higher than that of the secondary batteries in Example 5 and Comparative examples 6 and 7, and it is understood that the cycle characteristic is particularly excellent.

In Table 2, in the secondary batteries of Examples 2 and 5 having molar ratio (M₂/M₁) of 0.5 to 1, the cycle characteristic at 60° C. is excellent as compared not only with the secondary batteries in Comparative examples 1 and 2, but also with the secondary batteries in Comparative examples 6 and 7 of which molar ratio (M₂/M₁) is out of the specified range.

Hence, as known from FIGS. 4 and 5, and Table 2, by defining the molar ratio (M₂/M₁) in a range of 0.5 to 1, the rate characteristic can be enhanced as compared with the batteries not containing ester phosphate, and excellent cycle characteristics are obtained at both room temperature and high temperature.

The second group is explained. In FIG. 6, the secondary batteries in Example 4 and Comparative example 8 using ester phosphate produced larger discharge capacity than the secondary battery of Comparative example 5 not containing ester phosphate, at any discharge rate of 0.1C, 0.2C, 0.4C, and 0.8C, and are superior in rate characteristic. A higher capacity is also obtained as compared with the secondary battery in Comparative example 2 containing nonafluorometehoxy butylene. The secondary battery in Comparative example 10 comprises a negative electrode containing graphite and a nonaqueous electrolyte with molar ratio (M₂/M₁) exceeding 1, same as the lithium secondary battery disclosed in Jpn. Pat. Appln. KOKAI Publication No. 11-329495. In this secondary battery in Comparative example 10, the discharge capacity became lower during the evaluation, the discharge capacity at 0.1C was very low at 0.20 mAh, and almost no discharge was detected at 0.4C and 0.8C.

In FIG. 7, the secondary battery in Example 4 having molar ratio (M₂/M₁) of 0.5 to 1 was high in discharge capacity maintenance rate after 30 cycles, as compared with the secondary battery in Comparative example 8 with molar ratio (M₂/M₁) of over 1. In the secondary battery in Comparative example 10, discharge characteristic was drastically lowered in the early stages of the charge and discharge cycles.

In Table 3, in the secondary battery of Example 4 having molar ratio (M₂/M₁) of 0.5 to 1, the cycle characteristic at 60° C. is excellent as compared with the secondary batteries in Comparative examples 2, 5 and 8. In the secondary battery in Comparative example 10, same as the result at room temperature, almost no discharge was observed from the first cycle.

Hence, as known from FIGS. 6 and 7, and Table 3, if the molten salt is changed from EMI.BF₄ to EMI.TFSI, by defining the molar ratio (M₂/M₁) in a range of 0.5 to 1, the rate characteristic can be enhanced as compared with the batteries not containing ester phosphate, and excellent cycle characteristics are obtained at both room temperature and high temperature.

Finally, the third group is explained. In FIG. 8, the secondary batteries in Examples 1, 3 and 4 and Comparative example 9 using ester phosphate produced larger discharge capacity than the secondary battery of Comparative example 3 not containing ester phosphate, at any discharge rate of 0.1C, 0.2C, 0.4C, and 0.8C, and are superior in rate characteristic. A higher capacity is also obtained as compared with the secondary battery in Comparative example 4 containing nonafluoromethoxy butylene.

Comparing Examples 1 and 3 with molar ratio (M₂/M₁) of 1, the secondary battery in Example 1 having molten salt of which anion component is BF₄ is larger in discharge capacity than the secondary battery of Example 3 having molten salt of which anion component is TFSI, at any discharge rate of 0.2C, 0.4C, and 0.8C, and for improvement of rate characteristic, it is known that BF₄ is preferred as anion component of molten salt.

In FIG. 9, the secondary batteries in Examples 1, 3, 4 and Comparative example 9 using ester phosphate are higher in discharge capacity maintenance rate after 30 cycles, as compared with the secondary batteries in Comparative Examples 3 and 4.

Comparing Examples 1 and 3 with molar ratio (M₂/M₁) of 1, the secondary battery in Example 1 having molten salt of which anion component is BF₄ is higher in discharge capacity maintenance rate after 30 cycles, as compared with the secondary battery of Example 3 having molten salt of which anion component is TFSI, and for the improvement of cycle characteristic, it is known that BF₄ is preferred as anion component of molten salt.

In Table 4, in the secondary batteries of Examples 1, 3, 4 having molar ratio (M₂/M₁) of 0.5 to 1, the cycle characteristic at 60° C. is excellent as compared not only with the secondary batteries in Comparative examples 3 and 4, but also with the secondary battery in Comparative example 9 having molar ratio (M₂/M₁) exceeding 1.

Comparing Examples 1 and 3 with molar ratio (M₂/M₁) of 1, the secondary battery in Example 1 having molten salt of which anion component is BF₄ is higher in cycle characteristic at 60° C., as compared with the secondary battery of Example 3 having molten salt of which anion component is TFSI, and for the improvement of high temperature cycle characteristic, it is known that BF₄ is preferred as anion component of molten salt.

Hence, as known from FIGS. 8 and 9, and Table 4, if using other molten salt than EMI.BF₄ or EMI.TFSI, by defining the molar ratio (M₂/M₁) in a range of 0.5 to 1, the rate characteristic can be enhanced as compared with the batteries not containing ester phosphate, and excellent cycle characteristics are obtained at both room temperature and high temperature.

According to the invention, as described herein, both rate characteristic and cycle characteristic can be satisfied in the nonaqueous electrolyte battery comprising electrolyte of high flame retardant effect.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A nonaqueous electrolyte battery comprising:
a positive electrode;
a negative electrode containing an active material providing a negative electrode working potential which is nobler than a lithium electrode potential, and whose potential difference from the lithium electrode potential is 0.5V or more; and
an electrolyte containing molten salt, ester phosphate and metal salt including at least one of alkaline metal salt and alkaline earth metal salt, and the electrolyte satisfying the following formula (1):
0.5≦(M₂/M₁)≦1 (1)
where M₁ is a molar number of the metal salt and M₂ is a molar number of the ester phosphate.

2. The nonaqueous electrolyte battery according to claim 1, wherein the molten salt includes a compound which provides a cation having an imidazolium structure.

3. The nonaqueous electrolyte battery according to claim 2, wherein the cation having an imidazolium structure is at least one cation selected from the group consisting of 1-ethyl-3-methyl imidazolium cation, 1-methyl-3-propyl imidazolium cation, 1-methyl-3-isopropyl imidazolium cation, 1-butyl-3-methyl imidazolium cation, 1-ethyl-2,3-dimethyl imidazolium cation, and 1-ethyl-3,4-dimethyl imidazolium cation.

4. The nonaqueous electrolyte battery according to claim 1, wherein the molten salt includes a compound which provides at least one anion selected from the group consisting of tetrafluoroborate anion, hexafluorophosphate anion, hexafluoromethane sulfonate anion, bis(trifluoromethane sulfonyl) amide anion, and dicyanamide anion.

5. The nonaqueous electrolyte battery according to claim 1, wherein the molten salt includes a compound which provides a cation having an imidazolium structure and a tetrafluoroborate anion.

6. The nonaqueous electrolyte battery according to claim 1, wherein the alkaline metal salt includes lithium tetrafluoroborate, lithium hexafluorophosphate, lithium hexafluoromethane sulfonate, lithium bis(trifluoromethane sulfonyl) amide, lithium bis(pentafluoroethane sulfonyl) amide, and lithium dicyanamide.

7. The nonaqueous electrolyte battery according to claim 1, wherein the molten salt includes a compound which provides a tetrafluoroborate anion, and the metal salt includes lithium tetrafluoroborate.

8. The nonaqueous electrolyte battery according to claim 1, wherein the molten salt includes a compound which provides a cation having an imidazolium structure and a tetrafluoroborate anion, and the metal salt includes lithium tetrafluoroborate.

9. The nonaqueous electrolyte battery according to claim 1, wherein the ester phosphate includes at least one selected from the group consisting of trimethyl phosphate, triethyl phosphate, tributyl phosphate, and triphenyl phosphate.

10. The nonaqueous electrolyte battery according to claim 1, wherein the molten salt includes a compound which provides a cation having an imidazolium structure, and the ester phosphate includes trimethyl phosphate.

11. The nonaqueous electrolyte battery according to claim 1, wherein the molten salt includes a compound which provides tetrafluoroborate anion, and the ester phosphate includes trimethyl phosphate.

12. The nonaqueous electrolyte battery according to claim 1, wherein the value of (M₂/M₁) satisfies the relation of 0.8≦(M₂/M₁)≦1.

13. The nonaqueous electrolyte battery according to claim 1, wherein the active material contains lithium titanate and/or iron sulfide.

14. The nonaqueous electrolyte battery according to claim 13, wherein the lithium titanate has a composition represented by Li₄₊ₓTi₅O₁₂ (−1≦x≦3) or Li₂Ti₃O₇.

15. The nonaqueous electrolyte battery according to claim 1, wherein a charge and discharge potential of the positive electrode is 3.8V or more than the lithium electrode potential.

16. The nonaqueous electrolyte battery according to claim 1, wherein the positive electrode contains a positive electrode active material represented by LiCoₓNi_{y}Mn_{z}O₂ (x+y+z=1, 0<x≦0.5, 0≦y<1, 0≦z<1).
